(19) United States
(12) Patent Application Publication
(10) Pub. No.: US 2004/0017346 A1
(43) Pub. Date: Jan. 29, 2004

(54) Application structure of bicolor liquid crystal display

(76) Inventors: Ming-Wei Chuang, Taipei Hsien (TW); Ming-Chih Chen, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/205,444

(22) Filed: Jul. 26, 2002

(51) Int. Cl. G09G 3/36

(52) U.S. Cl. 345/88

(57) ABSTRACT

Application structure of bicolor liquid crystal display including a driving integrated circuit having at least ⅛ duty period, ¼ bias LCD output and even number of common points. The segment points of the driving integrated circuit are simultaneously respectively connected to corresponding segment points of two liquid crystal panels of the bicolor liquid crystal display. Two halves of the common points of the integrated circuit are respectively connected to the common points of the two liquid crystal panels. In cooperation with a preset driving software, the liquid crystal display uses two colors to respectively display the results of operation or data processing with different properties.

### BACKGROUND OF THE INVENTION

The present invention is related to an application structure of bicolor liquid crystal display. In cooperation with a driving software, the bicolor liquid crystal display respectively displays different results or states with two colors for easy identification.

In comparison to light emitting diode, liquid crystal display is advantageous in less power consumption. However, the conventional liquid crystal display can only display single color and is unable to present various colors as necessary. Therefore, the conventional liquid crystal display can only achieve monotonous visual effect which can be hardly clearly identified.

Currently, LED back light measure is used in the liquid crystal display for varying the colors thereof. Different LED are used to create different colors of back light, whereby a single liquid crystal display can provide a displaying effect with different colors of back light. For example, in a mobile phone, different colors of back light corresponds to different calling numbers. The different colors of back light are also applicable to the AC printer calculator of a cashbox. Such measure is able to achieve better identification effect in a low illumination (dark) environment. However, the light box accommodating therein relevant units occupies much room and is not suitable for mini-type sophisticated product such as handheld electronic calculator. Moreover, the special driving circuit and light box structure of the light emitting diodes lead to high cost and great power consumption.

### SUMMARY OF THE INVENTION

It is therefore a primary object of the present invention to provide an application structure of bicolor liquid crystal display. In cooperation with a preset driving circuit and application software, the bicolor liquid crystal display uses at least two colors to respectively display different results of operation or data processing with different properties (for example, positive or negative value, credit or debit, yes or no). Therefore, the bicolor liquid crystal display can more apparently display the results for a user to more clearly identify.

It is a further object of the present invention to provide the above application structure of bicolor liquid crystal display in which there is no light box or relevant back light source. Therefore, the design space of the bicolor liquid crystal display is similar to the conventional monocolor liquid crystal display. Therefore, the room will not be occupied to affect the arrangement of other elements.

The present invention can be best understood through the following description and accompanying drawings wherein:

### BRIEF DESCRIPTION OF THE DRAWINGS

FIG. 1 is a sectional view of the structure of the bicolor liquid crystal display of the present invention; and

FIG. 2 is a block circuit diagram of the driving circuit of the bicolor liquid crystal display of the present invention.

### DETAILED DESCRIPTION OF THE PREFERRED EMBODIMENT

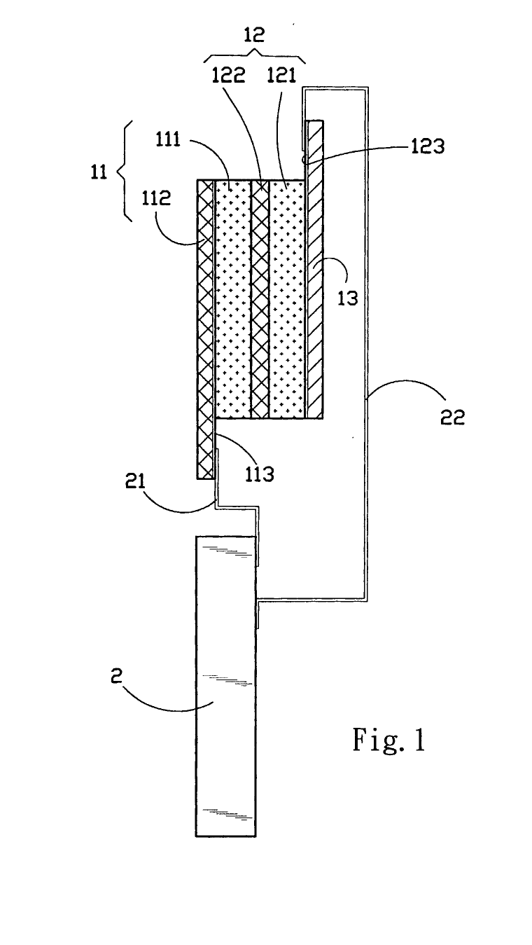

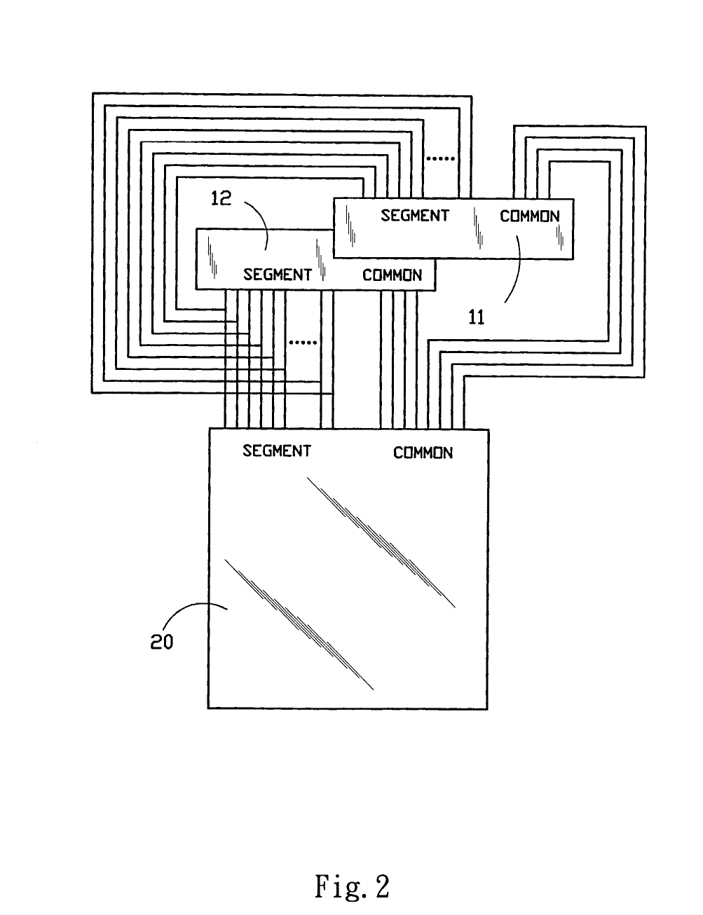

Please refer to FIGS. 1 and 2. The bicolor liquid crystal display 1 of the present invention includes a first and a second liquid crystal panels 11, 12 attached to each other and a reflective film 13. The first liquid crystal panel 11 is composed of a first liquid crystal film 111 and a first deflector 112. The second liquid crystal panel 12 is composed of a second liquid crystal film 121 and a second deflector 122. Under bias, the first and second liquid crystal films 111, 121 will display different colors. Respectively via transparent electrodes 113, 123 and first and second bus lines 21, 22 of a driving integrated circuit 20, the first deflector 112 and the reflective film 13 are connected to a circuit board 2. Press keys or other driving/driven control elements are disposed on the circuit board 2.

In the above assembly structure of the bicolor liquid crystal display 1 and the circuit board 2, a driving integrated circuit 20 is disposed on the circuit board 2. The driving integrated circuit 20 has at least ⅛ duty period and ¼ bias LCD output (having even number of common points). The segment points of the integrated circuit 20 are simultaneously respectively connected to the corresponding segment points of the first and second liquid crystal panels 11, 12 of the bicolor liquid crystal display 1. Two halves of the common points of the integrated circuit 20 are respectively connected to the common points of the two liquid crystal panels. In cooperation with a preset driving software, via different bias controls, the two colors can be used to respectively display results of operation or data processing with different properties.

The above embodiment is only used to illustrate the present invention, not intended to limit the scope thereof. Many modifications of the above embodiment can be made without departing from the spirit of the present invention.

What is claimed is:

1. Application structure of bicolor liquid crystal display in which the segment points of a driving integrated circuit are simultaneously respectively connected to corresponding segment points of two liquid crystal panels of the bicolor liquid crystal display and two halves of the common points of the integrated circuit are respectively connected to the common points of the two liquid crystal panels, whereby in cooperation with a preset driving software, the liquid crystal display uses two colors to respectively display the results of operation or data processing with different properties.

2. Application structure of bicolor liquid crystal display as claimed in claim 1, wherein the driving integrated circuit has at least ⅛ duty period, ¼ bias LCD output and even number of common points.
